(19) United States
(12) Patent Application Publication
(10) Pub. No.: US 2023/0114082 A1
(43) Pub. Date: Apr. 13, 2023

(54) FLUID CONTAINER WITH IMPROVED MOUNTING OF A SENSOR ARRANGEMENT WHICH PENETRATES THROUGH THE CONTAINER WALL

(71) Applicant: Röchling Automotive SE & Co. KG, Mannheim (DE)

(72) Inventor: Marco Barbolini, Bolzano (IT)

(21) Appl. No.: 17/948,304

(22) Filed: Sep. 20, 2022

(30) Foreign Application Priority Data
Oct. 8, 2021 (DE) 10 2021 126 128.7

(51) Int. Cl. B60S 1/50

(52) U.S. Cl. CPC B60S 1/50; G01N 27/07

(57) ABSTRACT

A fluid container, in particular for a motorized vehicle, with a container wall which surrounds a storage space of the container configured for the storage of fluid, and with an accommodating aperture penetrating through the container wall in which an elongated sensor arrangement penetrating through the container wall and extending along a longitudinal sensor axis is accommodated, where the sensor arrangement is mounted on the container by elastic mounting formations, where the longitudinal sensor axis defines an axial direction proceeding along the longitudinal sensor axis, radial directions proceeding orthogonally to the longitudinal sensor axis, and a circumferential direction encircling the longitudinal sensor axis, at least two elastic mounting formations configured separately from the sensor arrangement are arranged at an axial distance from one another, which extend radially between the sensor arrangement and a firmly container-mounted structure, where the mounting formations are fixed at one structure out of the sensor arrangement and firmly container-mounted structure and are braced against the respective other structure.

This application claims priority in German Patent Application DE 10 2021 126 128.7 filed on Oct. 8, 2021, which is incorporated by reference herein.

The present invention concerns a fluid container, in particular for a motorized vehicle, with a container wall which surrounds a storage space of the container configured for the storage of fluid, and with an accommodating aperture penetrating through the container wall in which an elongated sensor arrangement penetrating through the container wall and extending along a longitudinal sensor axis is accommodated, where the sensor arrangement is mounted on the container by elastic mounting formations.

### BACKGROUND OF THE INVENTION

Such a fluid container is known from EP 2 442 079 A1. This publication describes in detail a metal contact pin as the sensor arrangement, which is anchored at the synthetic material of the fluid container by a barb configured integrally at the metallic contact. A sensor arrangement mounted on the container wall by elastic mounting formations is mentioned in the publication in general terms, but not described in further detail.

Such sensor arrangements can serve for measuring the filling level, the reaching of a sufficient filling height, or also the quality of a fluid filled into the fluid container. Frequently the sensor arrangements are arranged pairwise in the fluid container, such that the sensor arrangements of a pair can form different poles of an electric measurement circuit. Depending on whether the two sensor arrangements of the sensor arrangement pair are immersed in a fluid stored in the fluid container or not, the conductance of the measurement circuit changes such that on the basis of the conductance in the measurement circuit it is possible to ascertain whether such a large quantity of fluid is stored in the storage space of the container that both sensor arrangements of the sensor arrangement pair are wetted. A threshold filling height thus to be detected, for instance a minimum filling height or a maximum filling height, can be specified through an appropriate spatial arrangement of the sensor arrangement pair at the fluid container.

Depending on the arrangement of the sensor arrangement pair and on the filling height of the fluid stored in the storage space, the immersion depth of the sensor arrangement pair and thereby an electric resistance or a capacitance formed by the sensor arrangement pair can change in the measurement circuit, such that a detection signal proportional to the filling height in the fluid container can be obtained with the detection of the electric resistance and/or of the capacitance in the measurement circuit.

If the sensor arrangements of the pair are arranged at the fluid container in such a way that as from a minimum filling height they are permanently wetted by the stored fluid with a constant wetting state independently of the filling height, an electric resistance or a capacitance formed by the sensor arrangement pair in the measurement circuit depends only on the electric and/or dielectric properties of the stored fluid, such that depending on a detection of the electric resistance or of the capacitance in the measurement circuit, a detection signal proportional to the fluid quality, for instance to its chemical composition or to the fraction of a predetermined component in the fluid, can be obtained.

Thus for example, operating fluids stored in motorized vehicles such as coolant, spray water for cleaning windshields and headlights, aqueous urea solution, and the like, can be detected in terms of quantity and/or quality.

The at least one sensor arrangement has to be arranged both leakproof and permanently firmly at the fluid container.

### SUMMARY OF THE INVENTION

The task of the present invention is to further develop the known fluid container in such a way that it can be manufactured at the smallest possible cost while having high functional reliability.

The present invention solves this task in a fluid container as described at the beginning by having at least two elastic mounting formations configured separately from the sensor arrangement which are arranged at an axial distance from one another and which extend radially between the sensor arrangement and a firmly container-mounted structure, where the mounting formations are fixed at one structure out of the sensor arrangement and the firmly container-mounted structure and are braced against the respective other structure.

In the present case, the longitudinal sensor axis is used as the basis of a coordinate system for describing the present invention, such that the longitudinal sensor axis defines an axial direction proceeding along the longitudinal sensor axis, radial directions proceeding orthogonally to the longitudinal sensor axis, and a circumferential direction encircling the longitudinal sensor axis. Unless specified otherwise in the present application, the terms “axial direction”, “radial direction”, and “circumferential direction” refer to the longitudinal sensor axis.

By configuring two simultaneously-acting elastic mounting formations, the sensor arrangement can be fixed axially sufficiently securely solely by force-fitting through the frictional forces acting between the mounting formations and the sensor arrangement. The frictional forces acting between the mounting formations and the structure bracing them can likewise be adjusted quantitatively through the choice of material for the mounting formations and through the choice of the dimensions and the material of the bracing structure, since given a known shape and implementation both of the bracing structure and of the firmly container-mounted structure, by choosing the material for the elastic mounting formations, the friction coefficient acting between them and the bracing structure can be influenced or more specifically adjusted. Moreover, the choice of material affects the modulus of elasticity and thereby the force achievable through elastic deformation of the mounting formations. The choice of dimensions and/or shape of the mounting formations also affects the force achievable through elastic deformation of the mounting formations.

Moreover, by configuring two elastic mounting formations at an axial distance from one another, the correct alignment of the sensor arrangement at the container wall can be fixed. In particular, thereby it is possible to achieve that the longitudinal sensor axis proceeds coaxially to a longitudinal aperture axis along which the accommodating aperture penetrating through the container wall preferably extends. Moreover, correct alignment of the sensor arrangement at the container wall ensures that a detecting section of the sensor arrangement is arranged in the storage space where according to the plan it should be arranged, such that it detects the fluid stored in the storage space at the desired location.

In principle, it can be provided that a mounting formation exhibits several mounting part-formations distributed in the circumferential direction and arranged at a distance from one another, which together exert a centering effect on the sensor arrangement. Thus for example, a mounting formation can exhibit three radial mounting struts arranged at an angular separation of 120°, or generally n at an angular separation of 360°/n. In this respect, preferably at least one mounting formation is configured as encircling in the circumferential direction. In order to obtain the most precise alignment possible and at the same time prevent tilting of the sensor arrangement about a tilt axis orthogonal to the longitudinal sensor axis, preferably all mounting formations are configured as encircling. For the best possible sealing of the sensor arrangement against fluid leakage, however, it is preferable that at least one mounting formation out of the at least two mounting formations is configured as encircling in the circumferential direction in a closed manner. To further increase the sealing effect of the attachment of the sensor arrangement to the container wall, preferably all mounting formations are configured as encircling in a closed manner. For example, each mounting formation can be configured as a radially projecting mounting and sealing lip encircling in the circumferential direction in a closed manner. Depending on whether a mounting formation is fixed to the sensor arrangement or to the firmly container-mounted structure, the mounting formation proceeds from its attachment radially outward or radially inward respectively.

In order to obtain an elastic mounting force which increases progressively with progressive deformation at the bracing point, at least one mounting formation configured as encircling in a closed manner can be configured as tapering in the radial direction. Preferably the mounting formation tapers in a direction away from its structure which is attaching it towards the structure which is bracing it. Since normally the mounting formation is deformed in the braced state, the tapered configuration refers to the undeformed state of the mounting formation, i.e. to a state in which the mounting formation is not braced against the structure which braces it in the operational state. Preferably more than one mounting formation, especially preferably all mounting formations, are configured as tapering in the radial direction.

Usually at least one mounting formation touches, or preferably all mounting formations touch, at their one radial end-region the structure attaching them and at their opposite radial end-region the structure bracing them.

Thus in principle, a mounting formation fixed at its one radial end-region and deformed by bracing at its other radial end-region can bridge and tightly seal a radial gap between the sensor arrangement and the firmly container-mounted structure. In order to improve the sealing of the mounting of the sensor arrangement at the container there can, preferably axially between one mounting formation out of the at least two mounting formations and a radial projection of the firmly container-mounted structure, be accommodated a seal which abuts radially inside against the sensor arrangement and radially outside against a section of the container. By means of the additional seal, which for example can be formed by an O-ring, it is moreover possible to prevent that fluid stored in the storage space reaches the mounting formation or the mounting formations respectively if for example the stored fluid acts aggressively on the material of the mounting formation or the mounting formations respectively.

In principle, several or all mounting formations out of the at least two mounting formations can be configured with the same material and/or with the same shape. This simplifies the manufacturing process. In contrast, in order to allocate different functions or functional emphases to individual mounting formations, it can be provided that one mounting formation out of the at least two mounting formations differs with regard to its material and/or its shape from another mounting formation out of the at least two mounting formations. Thus out of at least two mounting formations, both can contribute to the mounting of the sensor arrangement on the container, where one makes a stronger contribution to sealing a radial gap between the sensor arrangement and the container and/or the container-mounted structure and a weaker contribution to the positional fixing of the sensor arrangement at the container than another mounting formation, and where the other mounting formation makes a stronger contribution to the positional fixing of the sensor arrangement but a weaker contribution to sealing the radial gap. In total, this distribution of functional emphasis can lead to overall better sealing and to overall better positional fixing.

A difference in the material between two mounting formations is already present if the two mounting formations are made of a fiber- and/or particle-filled synthetic, in particular a thermoplastic synthetic, and both mounting formations exhibit the same matrix synthetic material and the same filling material but a different degree of filling.

The sensor arrangement and the firmly container-mounted structure preferably define an accommodating space for accommodating the aforementioned optional seal in the radial direction. Normally here, the sensor arrangement confines the accommodating space radial inward and the firmly container-mounted structure radially outward.

A mounting formation can confine the accommodating space in the axial direction. The container wall in general or the radial projection of the firmly container-mounted structure in particular can face the mounting formation in the axial direction and thus confine the accommodating space likewise in the axial direction, but in a direction away from the mounting formation.

An advantage of using different materials and/or shapes in at least two mounting formations can consist in the fact that one mounting formation as a more rigid mounting formation, due to its material and/or its shape, offers a greater deformation resistance against a radial and/or axial deformation in a direction towards the structure fixing it out of the sensor arrangement and the firmly container-mounted structure and/or against an axial deformation than a softer-elastic mounting formation arranged axially at a distance from the more rigid mounting formation. Preferably, this more rigid mounting formation confines the accommodating space of the optional seal, such that preferably the seal is arranged between the radial projection and a more rigid mounting formation.

In principle, the firmly container-mounted structure can be arranged at the container wall immovably relative to it, for example through gluing or by utilizing separate fasteners, although this is not preferred. Preferably, the firmly container-mounted structure is configured integrally with the container wall. Injection-molding manufacture of the container wall, for example as one of at least two container shells which are bonded to make the fluid container, permits great structural freedom in the integral configuration of the firmly container-mounted structure together with the container wall.

For example, the firmly container-mounted structure can at least section-wise form a sleeve surrounding the sensor arrangement radially outside. Thereby the section of the sensor arrangement surrounded by the firmly container-mounted structure can be shielded by the firmly container-mounted structure and thus protected. Furthermore, a firmly container-mounted structure configured as sleeve-shaped can serve as a socket for accommodating a plug to be connected with the sensor arrangement. With such a plug, a sensor signal can be picked up off the sensor arrangement and transmitted to a data processing device. In this case, the sleeve-shaped firmly container-mounted structure is configured on the outside of the container wall facing away from the storage space, in particular protruding outward from the container wall.

The firmly container-mounted structure can, once again preferably as a sleeve, additionally or alternatively be arranged on the inside of the container wall facing towards the storage space.

The configuration of the firmly container-mounted structure as a sleeve protruding from the container wall is also advantageous for the case where between the firmly container-mounted structure and the sensor arrangement there is arranged a seal. To wit, then the seal can abut radially outside against the firmly container-mounted structure in a closed encircling manner and thus be constantly pretensioned radially inward in the circumferential direction.

The preferable sleeve form notwithstanding, the firmly container-mounted structure can also exhibit a plurality of crosspieces following one another at a distance in the circumferential direction, which protrude on one side from the container wall inwards and/or outwards. Such axially protruding crosspieces can be connected with each other in axial sections by circumferential crosspieces. Therefore the firmly container-mounted structure can also exhibit at least section-wise a cage-like shape.

Preferably the sensor arrangement, if it is the structure bracing the mounting formations, is step-free in the region of the bracing and exhibits an outer surface continuous in the axial direction and in the circumferential direction which preferably is jump- and step-free.

However, when between the mounting formations and the sensor arrangement, in addition to the force- and/or frictionally-engaged connection, a positive-locking connection should also be realized in order to achieve the highest possible positional security of the sensor arrangement at the container wall, the sensor arrangement can exhibit at least one, preferably at least two radial grooves arranged at an axial distance from one another, where one mounting formation engages in the radial groove and thereby is either fixed at the sensor arrangement or is braced against it. When at least two radial grooves are configured at the sensor arrangement, then for at least two radial grooves it is the case that in each radial groove there is fixed or braced a different mounting formation.

When the at least two mounting formations are braced against the sensor arrangement, then preferably at least one mounting formation is braced at the groove base of a radial groove. For the reasons already mentioned above, the groove base then preferably exhibits an outer surface continuous and jump- and step-free in the axial direction and in the circumferential direction.

Since in order to facilitate the assembly of the sensor arrangement at the container wall, preferably all mounting formations are fixed at the same structure and braced at the same respectively other structure, the sensor arrangement preferably exhibits numerically no more radial grooves than there are provided mounting formations for mounting the sensor arrangement. For example, there can be configured at the sensor arrangement exactly as many radial grooves as there are provided mounting formations at the container.

In order to avoid possibly harmful notch effects and stress spikes in at least one mounting formation, it is preferably provided that at least one, preferably all, of the two mounting formations exhibit at their braced radial end-region—when considering the mounting formations in the undeformed state in a longitudinal section view in a sectional plane containing the longitudinal sensor axis—a convex outer surface. For the same reason, preferably the abutment surface at the bracing structure against which the at least one mounting formation braces is free from steps and jumps, in particular designed as cylindrical or conical.

According to a first possible structural configuration, the at least two mounting formations can be fixed at the firmly container-mounted structure and project from the latter radially inward. In the undeformed state, the clear width of a mounting formation is then preferably smaller than the diameter of the sensor arrangement, in particular than the diameter of the sensor arrangement in the axial section of the sensor arrangement provided for bracing abutment of the mounting formation. Thereby it can be made certain that the mounting formation can be deformed radially by the bracing abutment against the sensor arrangement and thus can abut against the sensor arrangement with prestressing.

In principle, the at least two mounting formations can initially be manufactured as components configured separately from the firmly container-mounted structure and glued or connected in some other way with the firmly container-mounted structure. A connection of a mounting formation with the firmly container-mounted structure which is especially rapid and simple to manufacture and at the same time especially secure, can be obtained by having at least one, preferably all, of the at least two mounting formations firmly bonded with the firmly container-mounted structure, in particular by injection molding, in particular at least partially overmolding, and thus fixed to the firmly container-mounted structure. Once again, injection molding manufacture of the container structure, preferably together with a container shell exhibiting it, and of the at least one mounting formation, is advantageous to this end. If a material is desired for the at least one mounting formation which differs from the material of the firmly container-mounted structure, for instance with a filling of the thermoplastic synthetic of the firmly container-mounted structure and the mounting formation which differs in shape and/or quantity, this can be achieved through a two- or multi-component injection-molding method.

In the event that at least one mounting formation is to be formed from the same material as the firmly container-mounted structure fixing it, this at least one mounting formation can be configured integrally with the firmly container-mounted structure, for instance by injection molding.

Alternatively, the at least two elastic mounting formations can be fixed at the sensor arrangement. The two elastic mounting formations are then preferably formed through by overmolding the sensor arrangement with an optionally filled thermoplastic synthetic. For better anchoring of at least one mounting formation to the sensor arrangement, it can be fixed to the sensor arrangement in the region of an aforementioned radial groove. To this end, the mounting formation overmolded around the sensor arrangement preferably fills the radial grooves completely and extends especially preferably axially on at least one, preferably on both sides, beyond the radial grooves.

Preferably the sensor arrangement performs sensing in the storage space of the container and permits the picking up of a sensor signal outside the storage space. In order to make sure that the sensor arrangement can transmit a sensor signal generated in the storage space through the container wall to the outside, the sensor arrangement is configured as electrically conducting along its longitudinal sensor axis. To this end, the sensor arrangement can comprise a metal rod or be a metal rod. The sensor arrangement is preferably configured as electrically conducting over at least 90%, especially preferably over its entire axial extension length.

In order to achieve the best possible compromise between low costs and high mechanical and chemical durability, the metal of the sensor arrangement, in particular in the shape of a metal rod, is preferably stainless steel. The sensor arrangement is preferably only one metal rod. The metal rod can be coated galvanically section-wise with another metal, for example with a noble metal.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1A rough schematic longitudinal section through a sensor arrangement-securing section of a fluid container of a first embodiment according to the invention,

FIG. 2A rough schematic longitudinal section through a sensor arrangement-securing section of a fluid container of a second embodiment according to the invention, and

FIG. 3A rough schematic longitudinal section through a sensor arrangement-securing section of a fluid container of a third embodiment according to the invention.

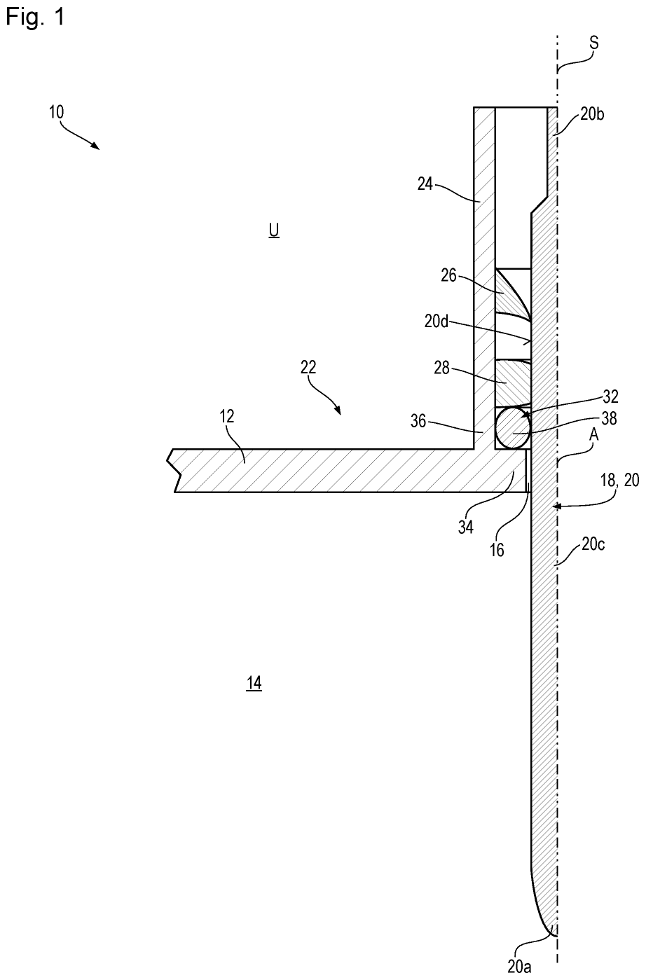

Since in the depicted examples, the sensor arrangement is configured largely, and the firmly container-mounted structure completely, as rotation-symmetrical with respect to the longitudinal sensor axis, in order to simplify the depiction in FIGS. 1 to 3 only the part of the section of the fluid container with the firmly container-mounted structure of the sensor arrangement which in each case lies on one side of the longitudinal sensor axis as the rotation symmetry axis is depicted.

FIGS. 1 to 3 are not to scale.

### DESCRIPTION OF PREFERRED EMBODIMENTS

Referring now to the drawings wherein the showings are for the purpose of illustrating preferred and alternative embodiments of the invention only and not for the purpose of limiting the same, in FIG. 1, a fluid container according to the invention is denoted generally by 10. The container 10 comprises a container wall 12 which surrounds a storage space 14, thus differentiating it from the external environment U. The fluid container 10 can for example serve for storing an operating fluid such as coolant, water, aqueous solutions, suspensions, and emulsions, of a motorized vehicle.

The container wall 12 exhibits an accommodating aperture 16 through which a sensor arrangement 20, for example configured as a metal rod 18, projects from the external environment U into the storage space 14. The longitudinal end 20a of the sensor arrangement 20 projecting into the storage space 14 is configured as a blunt tip tapering towards the longitudinal end. The longitudinal end 20b of the sensor arrangement 20 lying outside the storage space 14 is flattened and configured as a contact tab. Onto the latter there can be pushed a non-depicted contact shoe of a data transmission line, producing an electrically conducting contact. With the exception of the longitudinal end 20b configured as a contact tab, the sensor arrangement 20 is configured rotation-symmetrically with respect to the virtual longitudinal sensor axis S conceived as penetrating through it centrally.

The greater part 20c of the sensor arrangement 20 lying between the contact tab and the tapering tip is for example configured cylindrically.

The container wall 12 is part of a container shell 22 made by injection molding. Integrally with the container wall 12 there is configured a sleeve-like firmly container-mounted structure 24, which in the depicted example projects from the container wall 12 towards the external environment U, surrounding an axial section of the sensor arrangement 20.

To the firmly container-mounted structure 24 there is fixed a first elastic mounting formation 26 arranged further away from the container wall 12 in the shape of a retaining lip encircling the longitudinal sensor axis S in a closed manner in the circumferential direction.

To the firmly container-mounted structure 24 there is furthermore fixed a second elastic mounting formation 28 arranged nearer to the container wall 12. The second mounting formation 28 also encircles the longitudinal sensor axis S in a closed manner. However, whereas in the undeformed state the first mounting formation 26—when considering a longitudinal section in a sectional plane containing the longitudinal sensor axis S—exhibits for example a triangular cross-section, the second mounting formation 28 exhibits in the undeformed state in the same section for example a trapezoidal cross-sectional shape. Both mounting formations exhibit in the undeformed state considered above a convex contour designed for bracing against the sensor arrangement 20. In FIG. 1, both mounting formations 26 and 28 are shown in a deformed state in which they abut with their end-region which is remote from the firmly container-mounted structure 24 against the cylindrical outer surface 20d of the sensor arrangement 20. The deformed state exists in the fully assembled container 10, since the clear widths of the apertures formed respectively by the mounting formations 26 and 28 are smaller than the diameter of the cylindrical outer surface 20d of the sensor arrangement 20.

The first mounting formation 26 and the second mounting formation 28 are injected onto the firmly container-mounted structure 24 and firmly bonded with it. Despite this firmly bonded connection, the mounting formations 26 and 28 in FIG. 1 are depicted with hatching which differs between them and from the firmly container-mounted structure 24. This is meant to indicate that the mounting formations 26 and 28 are formed from different materials and that each material used for manufacturing a mounting formation 26 and 28 also differs from the material of the firmly container-mounted structure 24. In the present case, the materials of the firmly container-mounted structure 24, of the first mounting formation 26, and of the second mounting formation 28 do preferably exhibit the same thermoplastic synthetic, which facilitates the firmly bonded connection, but a different degree of filling with glass fibers.

For example, in order to obtain the most stable container possible, the container wall 12 and the firmly container-mounted structure 24 can exhibit the highest degree of filling with glass fibers. The first mounting formation 26 as a softer-elastic mounting formation preferably exhibits a lower degree of filling with glass fibers than the second mounting formation 28, which forms a more rigid mounting formation. However, the filling degree of the second mounting formation 28 with glass fibers can also be lower than that of the firmly container-mounted structure 24. Thus a stiff firmly container-mounted structure 24 with elastically deformable mounting formations 26 and 28 fixed onto it in a firmly bonded manner can be formed.

Due to the material which is filled with glass fibers to a greater degree and further due to its trapezoidal shape in the undeformed state, the deformation of the second, more rigid mounting formation 28 effects a greater normal force of the mounting formation 28 on the sensor arrangement 20 than the deformation of the first, softer-elastic mounting formation 26. The first mounting formation 26 thus contributes more strongly to the sealing of a radial gap 30 between the firmly container-mounted structure 24 and the sensor arrangement 20, whereas the second mounting formation 28 contributes more strongly to the axial fixing of the sensor arrangement 20 at the container 10.

For even more secure sealing of the radial gap 30, a seal 38, for example an O-ring, can optionally be arranged in the annular accommodating space 32 between a radial projection 34 and a sleeve section 36 of the firmly container-mounted structure 24, the second mounting formation 28, and the sensor arrangement 20. The seal 38 abuts radially outside against the sleeve section 36 of the firmly container-mounted structure 24 and radially inside against section 20c of the sensor arrangement 20.

For operational assembly of the sensor arrangement 20 at the container 10, the sensor arrangement 20 has merely to be led from the external environment U through the accommodating aperture 16. In the embodiment of FIG. 1, the sensor arrangement 20 is retained at the firmly container-mounted structure 24 solely through frictional engagement. Due to the alignment of the sensor arrangement 20 through the two mounting formations 26 and 28, the longitudinal sensor axis S is coaxial with the virtual aperture axis A conceived as penetrating centrally through the accommodating aperture 16.

Due to the elasticity of the mounting formations 26 and 28 and the frictional force acting respectively between them and the sensor arrangement 20, the sensor arrangement 20 is not displaced relative to the container wall 12 through vibrations and the like during the service life of the container 10.

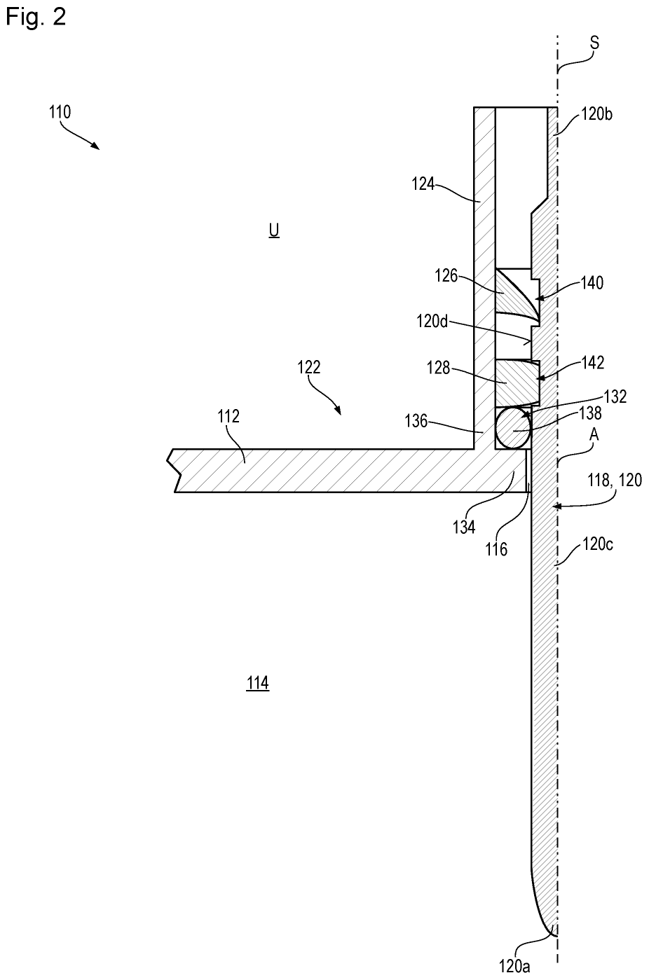

In FIG. 2, a second embodiment of a fluid container according to the invention is depicted and denoted by 110. Identical and functionally identical components and component sections as in the first embodiment of FIG. 1 are labeled in the second embodiment of FIG. 2 by the same reference numbers, but increased numerically by 100.

The second embodiment depicted in FIG. 2 is described hereunder only in so far as it differs from the first embodiment, whose description otherwise serves also for elucidating the second embodiment.

The second embodiment corresponds essentially to the first embodiment, with the difference that at the sensor arrangement 120 a first radial groove 140 located nearer to the longitudinal end 120b and a second radial groove 142 located nearer to the longitudinal end 120a are formed.

The first mounting formation 126 is braced with its longitudinal end which lies further away from the firmly container-mounted structure 124 fixing the first mounting formation 126 against the groove base of the first radial groove 140 and abuts against it. The second mounting formation 128 is braced analogously with its longitudinal end which lies further away from the firmly container-mounted structure 124 fixing the second mounting formation 128 against the groove base of the second radial groove 142 and abuts against it.

Since, therefore, the first radial groove 140 braces the first elastic mounting formation 126 and since the second radial groove 142 braces the second elastic mounting formation 128, the first and the second radial groove 140 and 142 respectively like the associated mounting formations 126 and 128 respectively encircle the longitudinal sensor axis S in a closed manner. In the depicted embodiment, the radial grooves are depicted with a rectangular groove cross-section. This, however, need not be the case. Instead of a rectangular groove cross-section, the groove cross-section can exhibit some other arbitrary shape, for example trapezoidal, part of a circle, part of an ellipse, generally polygonal, or curved. In order to protect the mounting formations, preferably the groove base bracing the mounting formations is jump- and step-free in the axial direction and in the circumferential direction.

Through the engagement of the mounting formations 126 and 128 with the radial grooves 140 and 142 respectively, in addition to the solely frictionally engaged mounting of the first embodiment there can be achieved a certain degree of positive locking which in addition to the frictional engagement contributes to fixing the sensor arrangement 120 to the container wall 112.

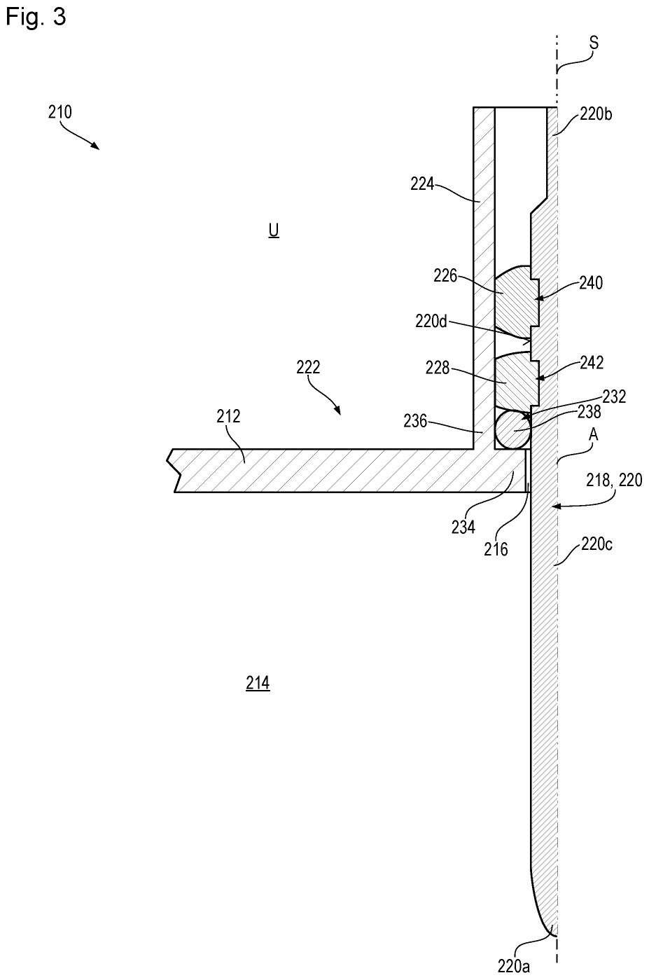

In FIG. 3, a third embodiment of a fluid container according to the invention is depicted and denoted by 210. Identical and functionally identical components and component sections as in the first embodiment of FIG. 1 are labeled in the third embodiment of FIG. 3 by the same reference numbers, but increased numerically by 200. Identical and functionally identical components and component sections as in the second embodiment of FIG. 2 are labeled in the third embodiment of FIG. 3 by the same reference numbers, but increased numerically by 100.

The third embodiment depicted in FIG. 3 is described hereunder only in so far as it differs from the first two embodiments, whose descriptions otherwise serve also for elucidating the third embodiment.

In the third embodiment, the metal rod 218 of the sensor arrangement 220 is configured identically to the metal rod 118 of the sensor arrangement 120 of the second embodiment. The difference between the third embodiment and the two preceding embodiments lies in the fact that the mounting formations 226 and 228 of the third embodiment are fixed at the metal rod 218 of the sensor arrangement 220 and are braced at the inner surface of the sleeve-like firmly container-mounted structure 224.

For the fixing of the mounting formations 226 and 228, the metal rod 218 is overmolded by the synthetic material of the respective mounting formation such that the formation of the mounting formations 126 and 128 and their fixing at the metal rod 218 of the sensor arrangement 220 take place simultaneously. In principle, the metal rod 218 could also be configured without radial grooves 240 and 242 and be overmolded by synthetic material of the respective mounting formation. In the present case, in the third embodiment the radial grooves 240 and/or 242 respectively are utilized in order to achieve with the overmolding not only a flow of force of the respective synthetic material with the metal rod 218, but additionally positive locking. To this end, the synthetic material of each mounting formation 226 and 228 fills completely the radial groove 240 or 242 respectively associated with it. Furthermore, each mounting formation 226 and 228 extends preferably axially a little way beyond the radial groove 240 or 242 respectively fixing the respective mounting formation 226 or 228, such that the radial gap between the radial sides of the radial grooves 240 or 242 respectively and the synthetic material lying in-between of the mounting formation 226 or 228 respectively fixed at the respective radial groove 240 or 242 is covered by further synthetic material of the mounting formation.

As shown in FIG. 3, the first mounting formation 226 can also exhibit in the undeformed state for example a trapezoidal cross-section with a convex abutment contour, when considering a sectional view in a sectional plane containing the longitudinal sensor axis S. This should express, in principle, that the cross-sectional shapes of the mounting formations shown in FIGS. 1 to 3 can differ from the respective depicted shape.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-14. (canceled)

15. A fluid container, in particular for a motorized vehicle, with a container wall which surrounds a storage space of the container configured for the storage of fluid, and with an accommodating aperture penetrating through the container wall in which an elongated sensor arrangement penetrating through the container wall and extending along a longitudinal sensor axis is accommodated, where the sensor arrangement is mounted on the container by elastic mounting formations, where the longitudinal sensor axis defines an axial direction proceeding along the longitudinal sensor axis, radial directions proceeding orthogonally to the longitudinal sensor axis, and a circumferential direction encircling the longitudinal sensor axis, wherein at least two elastic mounting formations configured separately from the sensor arrangement are arranged at an axial distance from one another, which extend radially between the sensor arrangement and a firmly container-mounted structure, where the at least two elastic mounting formations are fixed at one structure out of the sensor arrangement and the firmly container-mounted structure and are braced against the respective other structure.

16. The fluid container according to claim 15, wherein at least one elastic mounting formation out of the at least two elastic mounting formations is configured as encircling in the circumferential direction.

17. The fluid container according to claim 15, wherein all elastic mounting formations out of the at least two elastic mounting formations are configured as encircling in the circumferential direction in a closed manner.

18. The fluid container according to claim 15, wherein axially between a mounting formation out of the at least two elastic mounting formations and a radial projection of the firmly container-mounted structure there is accommodated a seal which abuts radially inside against the sensor arrangement and radially outside against a section of the container.

19. The fluid container according to claim 15, wherein a mounting formation out of the at least two elastic mounting formations differs with regard to its material and/or its shape from a further mounting formation out of the at least two elastic mounting formations.

20. The fluid container according to claim 19, wherein axially between a mounting formation out of the at least two elastic mounting formations and a radial projection of the firmly container-mounted structure there is accommodated a seal which abuts radially inside against the sensor arrangement and radially outside against a section of the container and wherein the seal is arranged between the radial projection and a more rigid mounting formation, where the more rigid mounting formation due to its material and/or its shape offers a greater deformation resistance against a radial deformation in the direction towards the structure fixing it out of the sensor arrangement and the firmly container-mounted structure and/or against an axial deformation than a softer-elastic mounting formation arranged axially at a distance from the more rigid mounting formation.

21. The fluid container according to claim 15, wherein the firmly container-mounted structure is configured integrally with the container wall.

22. The fluid container according to claim 15, wherein the firmly container-mounted structure forms at least section-wise a sleeve surrounding the sensor arrangement radially outside.

23. The fluid container according to claim 15, wherein the sensor arrangement exhibits at least one radial groove, where in the radial groove there is fixed or braced a mounting formation.

24. The fluid container according to claim 23, wherein the sensor arrangement exhibits at least two radial grooves arranged at an axial distance from one another, where for at least two radial grooves it is the case that in each radial groove there is fixed or braced a different mounting formation.

25. The fluid container according to claim 15, wherein at least one of the at least two elastic mounting formations exhibits at its braced radial end-region, when considering the mounting formations in the undeformed state in a longitudinal section view in a sectional plane containing the longitudinal sensor axis, a convex outer surface.

26. The fluid container according to claim 15, wherein all of the at least two elastic mounting formations exhibits at its braced radial end-region, when considering the mounting formations in the undeformed state in a longitudinal section view in a sectional plane containing the longitudinal sensor axis, a convex outer surface.

27. The fluid container according to claim 15, wherein the at least two elastic mounting formations are fixed at the firmly container-mounted structure and project from the latter radially inward.

28. The fluid container according to claim 27, wherein at least one of the two elastic mounting formations is firmly bonded with the firmly container-mounted structure and thus fixed to the firmly container-mounted structure.

29. The fluid container according to claim 27, wherein all of the two elastic mounting formations are firmly bonded with the firmly container-mounted structure by injection molding and thus fixed to the firmly container-mounted structure.

30. The fluid container according to claim 15, wherein the sensor arrangement along its longitudinal sensor axis is configured as electrically conducting.

31. The fluid container according to claim 15, wherein the sensor arrangement along its entire longitudinal extension is configured as electrically conducting.

32. The fluid container according to claim 30, wherein the sensor arrangement comprises a metal rod or is a metal rod.
